(19) United States
(12) Patent Application Publication
(10) Pub. No.: US 2008/0284069 A1
(43) Pub. Date: Nov. 20, 2008

(54) Leaf Spring Consisting of a Fibre Composite Material

(75) Inventors: Clemens Aulich, Magdeburg (DE); Rainer Forster, Odenthal-Voiswink (DE); Heiko Kempe, Magdeburg (DE)

Correspondence Address: Flindt Intellectual Property Law Group, PLLC, P.O. Box 1390, Issaquah, WA, 98027-0057, US

(73) Assignee: IFC COMPOSITE GMBH, Haldensleben (DE)

(21) Appl. No.: 12/093,328

(22) PCT Filed: Nov. 4, 2006
(86) PCT No.: PCT/DE2006/001937

§ 371 Date: May 19, 2008

(30) Foreign Application Priority Data
Nov. 12, 2005 (DE) 10 2005 054 376.6

(51) Int. Cl. F16F 1/368

(52) U.S. Cl. 267/7

(57) ABSTRACT

The invention relates to a leaf spring (1) consisting of a fibre-composite material and having a central longitudinal section (2) and two adjoining axial end sections for a wheel suspension in a vehicle, the end sections of said leaf spring tapering with respect to the leaf spring width. The leaf spring (1) is composed of resin-impregnated fibre layers and axially orientated uncut first fibres (6) of the fibre-composite material extend the full length of the leaf spring (1) to the two axial ends (5) of said spring. The axial ends (5) of the unfinished untreated leaf spring (1′), when viewed from above, have an essentially V-shaped geometry or an essentially V-shaped notch and thus form two respective limbs (8, 9) lying transversally to the longitudinal extension of the axis of the untreated leaf spring (11), said limbs (8, 9) abutting one another in the finished leaf spring (1). To further develop a leaf spring (1) of this type, according to the invention, the fibre fraction at least in the region (11) of the axial ends (5) of the untreated leaf spring (1′) is smaller than that contained in the neighbouring axial regions (2, 3, 4).

The invention relates to a leaf spring consisting of a fiber composite material pursuant to the generic term of claim 1.

Leaf springs are commonly used for wheel suspensions in vehicles in order to provide cushioning against uneven road surfaces. Such vehicles may include, but are not limited to, passenger vehicles, trucks, and other utility vehicles, and may also include railcars and similar vehicles.

Leaf springs made of steel have been known for some time. In such springs, narrow steel sheets of decreasing lengths are placed on top of one another in order to achieve a variable spring constant with increasing load. The sheets of the leaf springs are joined into a unit by means of clamps and/or screws. When mounting a leaf spring on a vehicle, this is done transversely to the direction of travel, for example, wherein the center area of the leaf spring is specified on the vehicle chassis, while the two axial ends of the leaf springs are arrayed in the area of the suspension for the right and left vehicle wheels. Even though a metal leaf spring is comparatively more cost-effective to manufacture and more reliable in operation, it nevertheless has the disadvantage of being heavy, which contributes to a relatively high vehicle weight and thus ultimately causes higher fuel consumption.

Also known are leaf springs made of fiber composite materials that are formed, for example, from glass or carbon fibers impregnated with synthetic resins, and which have comparable suspension properties with significantly less weight than steel leaf springs of the same size. Such fiber composite leaf springs are produced, for example, from individual resin-impregnated fiber layers known by the term “prepreg.” These prepregs are manufactured in and/or cut to the desired form and placed on top of each other in a press mold that corresponds to the dimensions of the leaf spring. The unfinished leaf spring in the press mold is then cured using pressure and heat.

DE 102 21 589 A1 describes a leaf spring made of a fiber composite material consisting of a single piece with a central arched section and peripheral sections on the ends. The peripheral sections have an eyelet on their respective axial ends with an opening to receive a bolt for the purpose of mounting the leaf spring to the vehicle chassis. The disadvantage of this lies in integrating the mounting eyelet into the leaf spring, which can be accomplished only with a structurally complex press mold or by a punching process that penetrates through the fibers.

In other leaf spring designs made of fiber composite materials, the end sections are beveled. Here each end section is cut to the appropriate beveled form after the leaf spring is cured. As a result, the fibers of the material are also cut. With long-term variable loads on the leaf spring, the sites of the cuts often develop cracks that extend outward from the sites of the cuts and primarily run parallel to the longitudinal extension of the fibers. These cracks may in turn cause the leaf spring to break.

EP 0 093 707 B1 and the parallel U.S. Pat. No. 4,557,500 B1 describe a leaf spring produced from a fiber composite material that is narrower and thicker on its axial ends than in a central, rectangular section. In this design, the area of the axial ends of the leaf spring can be somewhat trapezoidal in top view. According to another variant, the surface of the rectangular cross-sections of the leaf spring can be constant from one end of the spring to the other. In another structural type of this leaf spring, the composite fibers are uncut from one axial end to the other. The geometry of the leaf spring is created by press molds during its manufacture.

Also known from DE 10 2004 010 768 A1 of the applicant is a leaf spring produced from a fiber composite material with a central longitudinal extension and axial ends for a wheel suspension on a vehicle, in which the axial ends are formed tapering with respect to the leaf spring width, and in which the axially orientated fibers of the fiber composite material extend, without being cut, up to the terminal edge of the leaf spring. In addition, this leaf spring is produced from resin-impregnated fiber layers that have a substantially V-shaped geometry or a V-shaped notch on the axial ends in top view during the manufacture of the leaf spring, and thus form two limbs lying transversally to the longitudinal extension of the leaf spring. These two limbs abut each other in the manufacturing process and are cured so that the final manufactured leaf spring is somewhat trapezoidal in the area of its ends and has no thickening of the material in this area.

Also known from this publication is that the thickness of the leaf spring can be reinforced in its central area by means of geometrically simple, rectangular fiber layers, using fiber layers fashioned appropriately to give the V-shaped axial ends of the leaf spring and extending across the entire length of the part.

A leaf spring according to DE 10 2004 010 768 A1 has several advantages because it can have essentially constant cross-section surfaces throughout almost its entire length as well as a largely constant thickness with a narrower width on the axial end, without having to be cut on its axial ends.

Structural studies of such leaf springs has shown, however, that during their production, when reshaping the legs on the V-shaped ends and in the subsequent pressing of the leaf spring, there was an insufficient outflow of resin of the fiber composite material from this end area of the leaf spring. The studies also showed that the fibers in this area had only insufficient longitudinal alignment, which reduced the load properties of the leaf spring.

The object of the invention is therefore to improve a leaf spring according to DE 10 2004 010 768 A1 such that a prespecified ratio of fibers and resin is present in all areas during its production and in the finished leaf spring, and that the fibers as a whole are non-convoluted and are aligned longitudinally.

The achievement of this object is shown by the features of claim 1. Advantageous embodiments and improvements of the invention are specified in the subclaims.

The invention is based upon the surprising discovery that by reducing the unidirectional fibers in the area of the axial ends of the leaf spring compared with adjacent areas during its manufacture, both an improved outflow of resin and thus also the desired extension of the fibers in this leaf spring area can be achieved.

The invention accordingly relates to a leaf spring consisting of a fiber composite material and having a central longitudinal section and two adjoining axial end sections for a wheel suspension in a vehicle, the end sections of said leaf spring tapering with respect to the leaf spring width, wherein the leaf spring is composed of resin-impregnated fiber layers and axially orientated uncut first fibers of the fiber composite material extend the full length of the leaf spring to the two axial ends of said spring, and in which the axial ends of the unfinished untreated leaf spring, when viewed from above, have an essentially V-shaped geometry or an essentially V-shaped notch and thus form two respective limbs lying transversally to the longitudinal extension of the axis of the untreated leaf spring, said limbs abutting one another in the finished leaf spring.

To achieve the object for a leaf spring of this type, the fiber fraction, at least in the region of the axial ends of the untreated leaf spring, is smaller than in the neighboring axial regions.

This simple action based upon knowledge of the invention achieves the result that when pressing the legs of the unfinished leaf spring together, a blockage in the axial outflow of the synthetic resin of said leaf spring is avoided.

In order to enable a particularly advantageous production according to the invention, an improvement of the basic idea has secondary, longitudinal fibers arrayed in the leaf spring in the regions neighboring the axial ends, said fibers maintaining an interval to these axial ends which is constant or which decreases in the direction of the central longitudinal axis of the leaf spring. Actual embodiments of this are described below.

A leaf spring according to the invention is also characterized by the fact that the first fibers and the second fibers are arrayed in layers on top of one another in the leaf spring. In doing so, the layers of the first fibers and the second fibers are preferably formed by prefabricated, elongated prepregs, wherein multiple prepregs with the first fibers are placed on top of one another in the leaf spring, such that on top of this a prepreg with the second fibers then follows, and one or more layers of prepregs with the first fibers are placed again on the last prepreg, followed again by a prepreg with the second fibers, and so forth. The precise number of the consecutively placed prepregs depends upon the dimensions of the leaf spring and the technical requirements for said spring.

According to another embodiment of the invention, the prepregs with the second fibers are cut from the same continuous material web as the prepregs with the first fibers. In this process, the respective prepregs can differ with respect to the cut edge geometry and their length.

A leaf spring according to the invention is constructed such that the distance of the second fibers from the axial ends of the unfinished leaf spring is selected such that when joining the legs under pressure, only a predetermined resin fraction remains in the leaf spring, and the first fibers extending from one end of the leaf spring to the other are longitudinally aligned by the outflowing excess synthetic resin or remain longitudinally aligned.

In order to achieve the result that the as yet unjoined legs of the unfinished leaf spring have a smaller fiber fraction than the neighboring regions axial to them, the second fibers and/or the prepregs with the second fibers can be of the same length as each other or can differ in length. In the case of second fibers with differing lengths, these maintain a predetermined, essentially constant axial distance from the right and left ends of the unfinished leaf spring. Because these axial end regions of the unfinished leaf spring are somewhat swallowtail-shaped, a layer of second fibers and/or a prepreg with the second fibers accordingly has this V-shaped final geometry as well. In the case of second fibers of equal lengths, the axial distance of these fibers to the two axial ends differs, because the unfinished leaf spring, as explained, has a V-shaped geometry on both ends. This will be explained in greater detail below in connection with actual embodiments.

According to another improvement of the invention, the second fibers are arrayed in two reinforcing sections between the end regions of the leaf spring. These reinforcing sections preferably also cover the mounting points for mounting the leaf spring on a vehicle chassis and/or on the chassis suspension. One embodiment provides two symmetrical eccentric mounting points for mounting the leaf spring on a vehicle chassis and two mounting points on the ends for connecting the leaf spring with wheel suspensions.

According to another feature of this leaf spring, between the reinforcing sections a central section is given in which no second fibers and/or prepregs with the second fibers are present.

Finally, the axial ends at least of the unfinished leaf spring can have essentially right-angle cut edges or essentially rounded axial ends relative to the longitudinal axis of the leaf spring.

A drawing is attached to the description in order to more clearly explain the invention. This shows

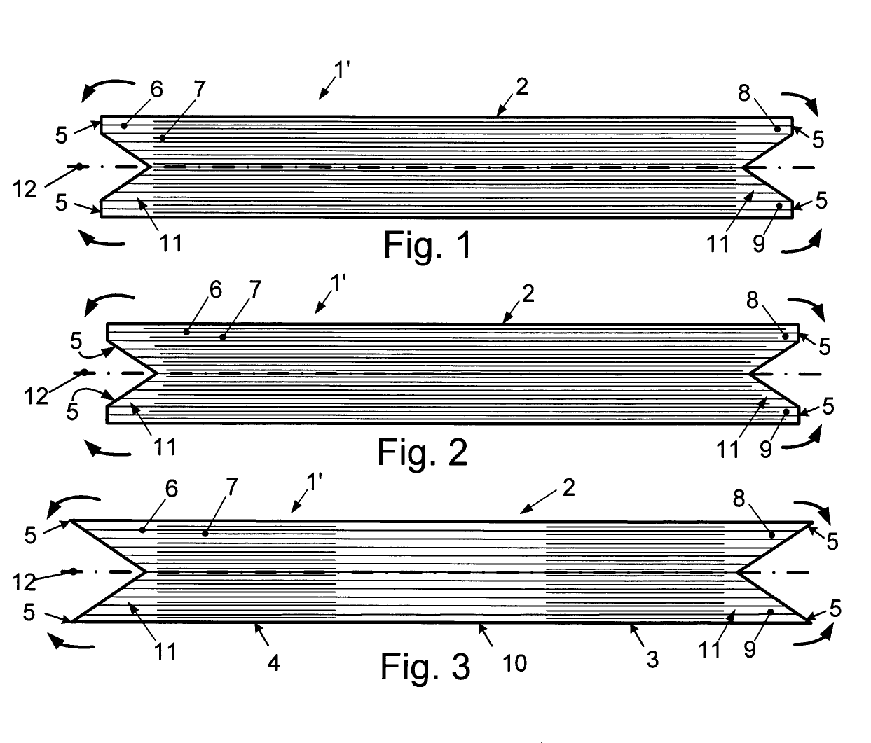

FIG. 1 a schematic top view of fiber layers in an unfinished leaf spring according to the invention with first fibers of unequal lengths and second fibers of equal lengths,

FIG. 2 an unfinished leaf spring as in FIG. 1, although with second fibers of differing lengths.

FIG. 3 an unfinished leaf spring similar to FIG. 1, although with pointed legs on the respective axial ends and with second fibers of equal lengths in two lateral reinforcing sections,

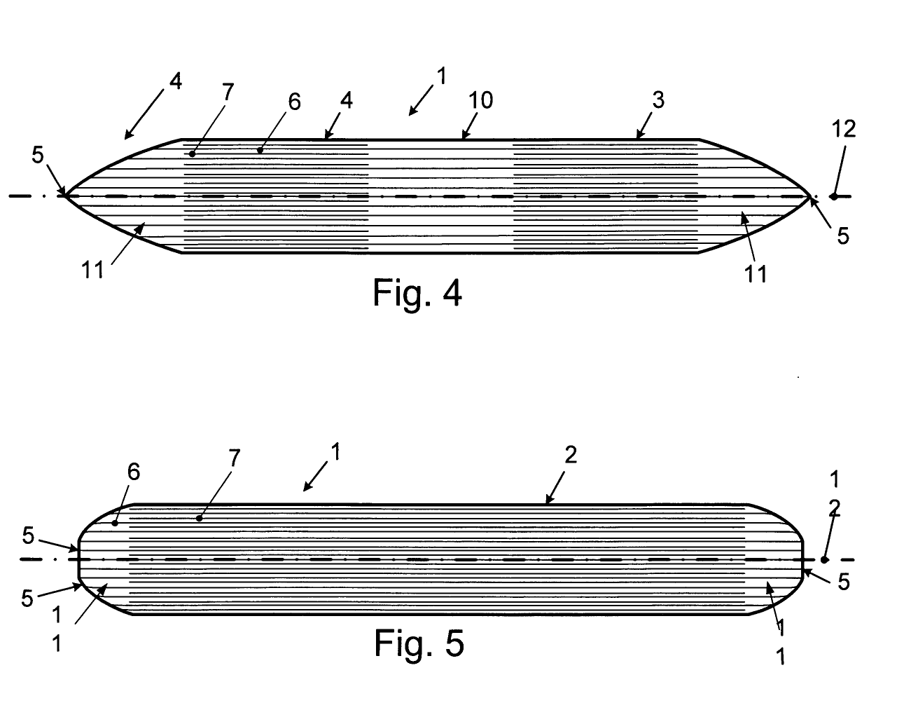

FIG. 4 a schematic view of a finished leaf spring with two lateral reinforcing sections and comparatively sharp axial ends, and

FIG. 5 a finished leaf spring shown as in FIG. 4, although with second fibers of equal length and rounded axial ends.

The leaf springs 1 shown in schematic top view according to FIGS. 4 and 5 are provided for a wheel suspension (not shown) on a motor vehicle (also not shown). They consist of a number of resin-impregnated unidirectional fiber layers and/or prefabricated prepregs laid on top of one another, which are bonded with one another in a manufacturing process in a press mold in a known manner. Both leaf springs 1 have unidirectional first fibers 6, which extend, without being cut, from one axial end 5 to the opposing axial end 5. In addition, these leaf springs 1 have unidirectional second fibers 7, which extend only over a portion of the leaf spring length, preferably the mounting regions, and which have differing distances to the axial ends 5.

The first fibers 6 and the second fibers 7 and/or the prepregs that contain the first fibers 6 and/or second fibers 7 are preferably cut from the same continuous material web and placed alternatingly on top of one another in differing numbers in the press mold in accordance with a placement plan. The fibers themselves are made of glass, carbon, or aramide, for example.

According to FIG. 4, leaf spring 1 also has largely sharp ends 5, while these ends 5 in the leaf spring pursuant to FIG. 5 are largely rounded, and each have edges that are aligned transversally to the longitudinal extension.

The production and different structural variants of the leaf springs according to the invention are shown in FIGS. 1 through 3, which are described in detail below. As shown by these figures, a so-called unfinished leaf spring 1′ is initially constructed by layering unidirectional first fibers 6, which are impregnated with a synthetic resin, for example an epoxy resin. These first fibers 6 are preferably consolidated in resin-impregnated fiber layers known as prepregs, which have a predetermined thickness that is significantly smaller than the thickness of finished leaf spring 1.

As previously mentioned, the first fibers or the prepregs with the first fibers 6 extend without being cut between the two axial ends 5 of the unfinished leaf spring 1′. To form the swallowtail-shaped axial ends 5 with the two legs 8 and 9 on the ends, the first fibers 6 are cut on their ends such that a final geometry of this type is created in unfinished leaf spring 1′. To construct such a leaf spring 1′, a predetermined quantity of first fibers 6 or the prepregs with the first fibers 6 is placed in a press mold (not shown). Unidirectional second fibers 7 or prepregs with the second fibers 7 are then placed on this stack in a predetermined layer thickness.

These second fibers 7 do not extend to the axial ends 5 of unfinished leaf spring 1′, but instead maintain a predetermined axial distance to these ends. The second fibers 7 are all of equal length in unfinished leaf spring 1 according to FIG. 1 and finished leaf spring 1 according to FIG. 5. In unfinished leaf spring 1′ according to FIG. 1, the axial distance of the second fibers 7 from the respective assigned axial ends decreases perceptibly from the exterior side of the longitudinal section 2 in the direction of the longitudinal axis 12 of leaf spring 1′.

In the second variant shown in FIG. 2, the second fibers 7 or the prepregs with the second fibers 7 are at a largely constant axial distance from the assigned axial ends 5 of unfinished leaf spring 1′. Here they extend more or less broadly axial up into the two legs 8,9 on the ends. FIG. 2 shows in simplified form on the right and left side two embodiments, in which the two axial ends of the layers of the second fibers 7 are actually geometrically identical, in other words cut with the same cutting tool.

Finally, FIG. 3 shows an unfinished leaf spring 1′, in which comparatively short layers with the second fibers 7 are embedded between layers of the first fibers 6. The second fibers 7 or the prepregs with the second fibers 7 are of equal length or have straight cut edges, such that the axial ends of the second fibers 7 have differing, specifically increasingly shorter distances to the assigned axial ends 5 from the exterior side of longitudinal section 2 in the direction of the longitudinal axis 12 of unfinished leaf spring 1′. In the process, the second fibers 7 or the prepregs containing the second fibers 7 are arrayed in the mounting regions 3, 4 of finished leaf spring 1 according to FIG. 4. Between these mounting regions 3, 4, a central section 10 is given, which is free of second fibers 7.

The first fibers 6 and second fibers and 7 are placed as described in the form of fiber layers or prepregs in the aforementioned press mold such that the legs 8 and 9 are pivoted on the axial ends 5 of unfinished leaf spring 1′ according to the curved arrows in FIG. 1 through 3 in the direction of the longitudinal axis 12 and are made to abut each other. Because only the first fibers 6 and/or a reduced fraction of second fibers 7 are present in these end regions 11 of unfinished leaf spring 1′, the joining of the aforementioned legs 8, 9 does not result in a blockage during the outflow of the synthetic resin during the pressing process. In addition, the axial outflow of the synthetic resin causes the first fibers 6 in the end sections of unfinished leaf spring 1′ to be or remain axially elongated, which is a prerequisite for very good mechanical properties of finished leaf spring 1. The still wet structure of unfinished leaf spring 1′ is then cured in the press mold using pressure and heat.

The selection of one of the presented variants to be used with regard to the length and arrangement of the second fibers 7, as well as the number and sequence of the fiber layers, depends upon the respective application and can be decided by the user.

### Drawing Reference

1 Leaf spring
2 Longitudinal section
3 Reinforcing section
4 Reinforcing section
5 Axial end
6 First fibers
7 Second fibers
8 Leg
9 Leg
10 Central section
11 End region
12 Longitudinal axis of leaf spring

1. The invention relates to a leaf spring (1) consisting of a fiber composite material and having a central longitudinal section (2) and two adjoining axial end sections for a wheel suspension in a vehicle, the end sections of said leaf spring tapering with respect to the leaf spring width. The leaf spring (1) is composed of resin-impregnated fiber layers and axially orientated uncut first fibers (6) of the fiber composite material extend the full length of the leaf spring (1) to the two axial ends (5) of said spring. The axial ends (5) of the unfinished untreated leaf spring (1′), when viewed from above, have an essentially V-shaped geometry or an essentially V-shaped notch and thus form two respective limbs (8, 9) lying transversally to the longitudinal extension of the axis of the untreated leaf spring (11), said limbs (8, 9) abutting one another in the finished leaf spring (1), characterized in that the fiber fraction, at least in the region (11) of the axial ends (5) of the untreated leaf spring (1′), is smaller than in the neighboring axial regions (2, 3, 4).

2. Leaf spring according to claim 1, characterized in that second longitudinally aligned fibers (7) are arrayed in the leaf spring (1, 1′) in the regions (2, 3, 4) neighboring the axial ends (5), said fibers maintaining a distance to these axial ends (5) which is constant or which decreases in the direction of the central longitudinal axis (12) of the leaf spring (1, 1′).

3. Leaf spring according to claim 1 or 2 characterized by the fact that the first fibers (6) and the secondary fibers (7) are arrayed in layers on top of one another in the leaf spring (1, 1′).

4. Leaf spring according to claim 3, characterized in that the layers of the first fibers (6) and the second fibers (7) are formed by prefabricated, elongated prepregs, wherein multiple prepregs with the first fibers (6) are placed on top of one another in the leaf spring (1, 1′), and on top of this a prepreg with the second fibers (7) then follows, followed by one or more layers of prepregs with the first fibers (6), followed by a prepreg with the second fibers (7), and so forth.

5. Leaf spring according to claim 4, characterized in that the prepregs with the second fibers (7) are cut from the same continuous material web as the prepregs of the first fibers (6).

6. Leaf spring according to at least one of claims 1 through 5, characterized in that the distance of the second fibers (7) from the axial ends (5) of the unfinished leaf spring (1′) is selected such that when joining the legs (8, 9) under pressure, only a predetermined resin fraction remains in the leaf spring (1′), and the first fibers (6) extending from one end (5) of the leaf spring (1) to the other are or remain longitudinally aligned.

7. Leaf spring according to at least one of claims 1 through 6, characterized in that the second fibers (7) have lengths that are equal to or different from each other.

8. Leaf spring according to at least one of claims 1 through 7, characterized in that the second fibers (7) are arrayed in a longitudinal section (2) of the leaf spring (1, 1′), which includes the mounting points for mounting the leaf spring (1) to a vehicle chassis and/or to the chassis suspension.

9. Leaf spring according to claim 8, characterized in that the longitudinal section (2) has a central section (10) and two reinforcing sections (3, 4) to the right and/or left of this section, wherein the second fibers (7) are arrayed only in the reinforcing sections (3, 4) of the leaf spring (1, 1′).

10. Leaf spring according to at least one of claims 1 through 9, characterized in that the axial ends (5) at least of the unfinished leaf spring (1, 1′) are essentially formed by right-angle cut edges or essentially rounded axial ends relative to the longitudinal axis (12) of the leaf spring (1).
